(19) United States
(12) Patent Application Publication
(10) Pub. No.: US 2024/0270913 A1
(43) Pub. Date: Aug. 15, 2024

(54) ION EXCHANGE MEMBRANES (IEMS) WITH IONIC LIGAND-METAL COMPLEX GROUPS AND METHODS THEREOF

(71) Applicant: XEROX CORPORATION, Norwalk, CT (US)

(72) Inventors: Kentaro Morimitsu, Mississauga (CA); Valerie M. Farrugia, Oakville (CA)

(73) Assignee: XEROX CORPORATION, NORWALK, CT (US)

(21) Appl. No.: 18/169,098

(22) Filed: Feb. 14, 2023

(51) Int. Cl. C08J 5/22; C08K 3/08

(52) U.S. Cl. CPC C08J 5/22; C08K 3/08; C08J 2425/04; C08J 2439/08; C08K 2003/0862

(57) ABSTRACT

An ion-exchange membrane including a polymer such as vinylpyridine, styrene, poly(4-vinylpyridine), or a poly(4-vinylpyridine-co-styrene) copolymer. The ion-exchange membrane also includes an ionic ligand-metal complex bonded to the vinylpyridine by a coordinate covalent bond. The ionic ligand-metal complex may include nickel-bipyridine. The ion-exchange membrane can be a free-standing membrane.

### TECHNICAL FIELD

The present teachings relate generally to compositions for ion exchange membranes and, more particularly, to ion exchange membranes including ionic ligand-metal complexes.

### BACKGROUND

Ion-exchange membranes (IEM) are semi-permeable membranes that can be used in electrochemical devices such as fuel cells, redox flow batteries, electrolyzers, reverse electrodialysis cells and bioelectrochemical systems (BES) such as microbial fuel cells. IEMs can be composed of hydrophobic substrates with immobilized ion-functionalized groups and mobile counterions. Depending on the type of ionic groups being transported, the IEMs can be anion exchange membranes (AEMs) or cation exchange membranes (CEMs). CEMs selectively transport cations (positively charged ions) across a permeable membrane. CEMs can be non-acidic such as those containing Na⁺ cations, or acidic in the case of proton-exchange membranes (PEMs) which specifically transport H⁺ cations. AEMs selectively transport anion and are available in non-alkaline anion forms (e.g. containing Cl⁻ anions) and alkaline anions, designated AAEM, for example, OH⁻, CO₃²— and HCO₃⁻. In general examples, ion-exchange membranes are semi-permeable membranes composed of ionic groups attached to polymer materials.

Depending on selection and ratio of monomers or comonomers, a variety of polymer structures can be designed. In order to functionalize polymers with anion exchange capability, cationic groups are attached to the polymer chains. There are several classes of cationic groups reported, including quaternary ammonium, phosphonium, imidazolium, guanidium, and ligand-metal complexes. The quaternary ammonium groups are most studied whereas the guanidium and ligand-metal complex are relatively newly developed. For the ligand-metal complex, considering combinations of ligand and metal, as well as monomer combinations, there is plenty of space to explore new materials, but these materials are not as well established.

While the aforementioned materials used in ion exchange membranes are typically polymers and cross-linked polymers, most known polymer chemistry synthesis processes do not provide precise control over the molecular-level structure of the formed material since most are randomly patterned. Most polymers are amorphous or partially amorphous except for some classes of linear polymers that can efficiently pack together resulting in high density with crystalline characteristics.

Therefore, it is desirable to fabricate ion exchange membranes that can be used in a variety of applications such as fuel cells, redox flow batteries, electrolyzers, reverse electrodialysis cells, and microbial fuel cells.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

An ion-exchange membrane is disclosed. The ion-exchange membrane includes a polymer which can include vinylpyridine. The ion-exchange membrane also includes an ionic ligand-metal complex bonded to the vinylpyridine by a coordinate covalent bond. Implementations of the ion-exchange membrane may include where the ionic ligand-metal complex includes nickel. The ionic ligand-metal complex may include nickel-bipyridine. The polymer may include poly(4-vinylpyridine) or styrene. The ionic ligand-metal complex may include a metal selected from the group may include of zinc, ruthenium, iron, and cobalt. The ionic ligand-metal complex may include bipyridine. The ionic ligand-metal complex may include pyridine, 2,2′:6′,2″-terpyridine, quinoline, 2,2′-biquinoline, 1,10-phenanthroline, 8-hydroquinoline, 8-aminoquinoline, or combinations thereof. The polymer may include 4-vinylpyridine. The polymer further may include styrene. The polymer further may include 4-vinylpyridine and styrene. A monomer unit of the polymer to ionic ligand-metal complex molar ratio is from about 100 to 1 to about 10 to 1. A thickness of the ion-exchange membrane is from about 250 nm to about 500 μm. The ion-exchange membrane has an ion exchange capacity (IEC) of from about 0.25 meq/g to about 5.00 meq/g. The ion-exchange membrane can be free-standing.

Another ion-exchange membrane is disclosed. The ion-exchange membrane includes a polymer which may include vinylpyridine and styrene. The ion-exchange membrane also includes an ionic ligand-metal complex bonded to the polymer by a coordinate covalent bond. The ionic ligand-metal complex may include bipyridine. The polymer may include 4-vinylpyridine and styrene. A monomer unit of the polymer to ionic ligand-metal complex molar ratio is from about 100 to 1 to about 10 to 1. A thickness of the ion-exchange membrane is from about 250 nm to about 500 μm. The ion-exchange membrane has an ion exchange capacity (IEC) of from about 0.25 meq/g to about 5.00 meq/g.

Another ion-exchange membrane is disclosed. The ion-exchange membrane includes a polymer which may include a poly(4-vinylpyridine-co-styrene) copolymer. The ion-exchange membrane also includes a nickel-bipyridine complex bonded to the polymer by a coordinate covalent bond. Implementations of the ion-exchange membrane include where the nickel-bipyridine complex is bonded to a 4-vinylpyridine segment of the poly(4-vinylpyridine-co-styrene) copolymer by a coordinate covalent bond.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIGS. 1A and 1B depict Fourier Transform Infrared (FTIR) spectra of polymer-Ni complex materials and starting materials including a PVP—Ni complex and a PVP-10% PS—Ni complex, respectively, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Ion exchange membranes (IEMs) refers to a layer or membrane that is a film at a macroscopic level. The IEMs of the present disclosure can include an ionic functional group, which is bonded into the IEM polymer network via at least one ligand-metal complex located on pendant groups of the polymer, which is formed from one or more monomers. IEMs of the present disclosure in certain examples can have non-ionic or ionic character, including cationic or anionic. This ionic character can be imparted by either a charged ligand-metal complex bonded to one or more monomer or polymer segments within the IEM polymer structure.

In this specification and the claims that follow, singular forms such as “a,” “an,” and “the” include plural forms unless the content clearly dictates otherwise.

Films as presently disclosed in a free-standing film example, or as coated onto a surface, include but are not limited to, a top surface and a bottom surface, in which “top” and “bottom” can be dependent on a temporal orientation or position of the film. Furthermore, a surface is still considered a surface even if adhered or bound to a substrate or other material. Films as presently disclosed in a free-standing film example, or as coated onto a surface, also include one or more edges, which can be, but are not limited to, one or more boundaries between where a film is present and where a film is not present.

The IEMs of the present disclosure are at the macroscopic level substantially pinhole-free IEMs or pinhole-free IEMs having continuous polymeric networks that can extend over larger length scales such as for instance much greater than a millimeter to lengths such as a meter and, in theory, as much as hundreds of meters. In examples, a “substantially pinhole-free IEM” or “pinhole-free IEM” may be formed from a polymer solution deposited on the surface of an underlying substrate. The term “substantially pinhole-free IEM” refers, for example, to an IEM that may or may not be removed from the underlying substrate on which it was formed and contains substantially no irregular pinholes, blisters, ruptures, or gaps, such as those that would be considered coating defects that could form such as when a bubble ruptures during a film formation that is greater than the distance between the cores of two adjacent segments per square cm: such as, for example, less than 10 pinholes, pores or gaps greater than about 250 nanometers in diameter per cm², or less than 5 pinholes, pores or gaps greater than about 100 nanometers in diameter per cm². The term “pinhole-free IEM” refers, for example, to an IEM that may or may not be removed from the underlying substrate on which it was formed and contains no unintended pinholes or gaps greater than the distance between the cores of two adjacent segments per square micron, such as no pinholes or gaps greater than about 500 Angstroms in diameter per square micron. Pores that are intentionally and uniformly introduced into IEMs as tunable features for transport via a membrane are distinguished from pinholes for the purposes of this disclosure.

A need for ion exchange membranes, or more specifically cationic or anionic functional exchange membranes containing ionic functional groups that can be used in a variety of applications such as fuel cells, redox flow batteries, electrolyzers, reverse electrodialysis cells, and microbial fuel cells can be addressed by using polymers with ionic functional groups. Such polymers can form or react to form one-, two-, or three-dimensional networks made up of one or more polymers, copolymers, or monomers that are linked to each other through strong covalent bonds. Examples of the present disclosure take advantage of a versatile polymer synthesis approach to design ion exchange membranes (IEMs) that also rely on and incorporate ionic functional groups including metal ligands at a macroscopic level and assembled as a film.

Ionic ligand-metal complex materials known to those skilled in the art have been prepared by polymerization of monomers that have been functionalized via coordinate covalent bonds with ionic ligand-metal complexes. As such, the monomers having ionic ligand-metal complexes are first synthesized prior to polymerization. It is expected the pyridine groups on poly(4-vinylpyridine) proceed to form metal complex using lone pairs on the nitrogen atoms, in implementations. In certain implementations, poly(4-vinylpyridine) and its copolymers can be commercially acquired and therefore the polymerization step can be avoided.

The present teachings provide a poly (4-vinylpyridine) and alternatively a poly(4-vinylpyridine-co-styrene) either of which can be functionalized via coordinate covalent bonds with metal complexes, such as nickel-bipyridine complexes, for use as anion exchange membranes in electrochemical cells. The materials can be synthesized by reacting the metal complex or the monomer functionalized via coordinate covalent bonds with a metal complex with commercially available polymers. Polymer films of resulting polymer materials can be prepared by casting polymer solutions on a surface and removing solvents. Characterizations of resulting polymer films can be performed from the materials, exhibiting sufficient ion exchange capacity (IEC), 0.88-1.02 meq/g, suitable for AEM applications, as well as other properties suitable for use in AEM and other membrane applications.

In examples of the present disclosure, an illustrative example of a polymer for use in an ionic exchange membrane includes poly(4-vinylpyridine). Poly(4-vinylpyridine) (P4VP) is a synthetic polymer made from monomeric 4-vinylpyridine. P4VP is a water-soluble polymer in certain conditions with a relatively high degree of polarity. A common method of polymerization for P4VP is by a radical polymerization reaction, which involves the initiation of polymerization by a radical initiator, followed by the propagation and termination of the polymer chain. Polymers similar to P4VP, which could be used in other implementations, include poly(2-vinylpyridine) and poly(4-vinylquinoline). P4VP can also be copolymerized with other monomers such as acrylonitrile, styrene, acrylate, methacrylate, ethylene, propylene, or butadiene to form a copolymer. In general, notable properties of P4VP include water solubility under acidic conditions, good thermal stability, and relatively high polarity. P4VP also has appreciable film-forming properties and is often used in films, coatings, and adhesives. In examples, P4VP is known to possess chelating properties and can be used in the reaction with or for removal of metal ions.

In examples of the present disclosure, poly(4-vinylpyridine-co-styrene) can be used as a polymer material in an ionic exchange membrane. Poly(4-vinylpyridine-co-styrene) (P4VP-co-PS) is a copolymer made utilizing the monomers 4-vinylpyridine and styrene. It is a water-insoluble polymer wherein the combination of the two monomers provides a combination of the properties of both P4VP and polystyrene (PS). P4VP-co-PS can be polymerized through a process called emulsion polymerization, which involves the polymerization of monomers in a water-based medium in the presence of an emulsifying agent. This process can also be carried out in the presence of a surfactant and initiator to form a stable emulsion. Notable properties of P4VP-co-PS include water insolubility, good thermal stability, chemical resistance, and a combination of the polarity and hydrophobicity of P4VP and PS. P4VP-co-PS also has appreciable film-forming properties and is often used in films, coatings, and adhesives and chelating properties as well.

One exemplary ligand that can be used to form a metal complex, and subsequently functionalize one or more of the polymers described herein can include 2,2′-bipyridyl. 2,2′-bipyridyl is a ligand that can form complexes with various metals. Some examples of 2,2′-bipyridyl complex reactions include the formation of [Cu(bipy)₂]²⁺, using 2,2′-bipyridyl coordinated to copper (II) ions. [Ni(bipy)₂]²⁺, using 2,2′-bipyridyl and nickel (II). Zn(bipy)₂]²⁺, using 2,2′-bipyridyl and zinc(II), and complexes using ruthenium, iron, cobalt, transition metals and other metals. Some examples of ligand of the ligand-metal complex include pyridine, 2,2′-bipyridine, 2,2′:6′,2″-terpyridine, quinoline, 2,2′-biquinoline, 1,10-phenanthroline, 8-hydroquinoline, 8-aminoquinoline, and substituted derivatives of thereof. A number of factors can influence the reactions of bipyridyl complexes with various metals, including ligand concentration, pH of the reaction mixture, temperature of the reaction, solvent used, the metal, as well as the presence of other metals or other ligands. In examples, higher concentrations of the ligand, such as 2,2′-bipyridyl, can lead to a faster formation of the complex, pH of the reaction mixture can provide a metal ion in different oxidations states, that can alter the formation of the complex, temperature can influence reaction speed or decomposition of the complex. It should be noted that both anionic and cationic complexes can be used in the IEMs described herein, but positively charged complexes and the resulting polymers form anionic exchange membranes (AEMs). In this case, anions, which are the counterions of the positively charged species, are what are exchanged in the mechanism of anion exchange membranes. Alternatively, negatively charged complexes and the resulting polymers form cationic exchange membranes (CEMs). In CEMs, cations, which are the counterions of the negatively charged species, are what are exchanged in the mechanism of cationic exchange membranes. In examples, suitable counterions for the anion-exchange membranes include halides such as Cl⁻, F⁻, Br⁻, I⁻; polyatomic anions such as NO₂⁻, NO₃⁻, SO₄²⁻, PO₄³⁻, ClO₄⁻, CH₃CO²⁻, HCO₃⁻, CO₃²⁻, OH⁻; PF₆⁻, BF₄⁻ and the like. In other examples, suitable counterions for the cation-exchange membranes include H⁺; alkali metals such as Cs⁺, Na⁺, K⁺, Li⁺, alkaline earth metals such as Ba²⁺, Mg²⁺, Be²⁺, Ca²⁺, Sr²⁺, Ra²⁺; Al³⁺; transition metal ions such as Fe²⁺, Fe³⁺, Ni²⁺, Ni³⁺, Cu²⁺, Cu³⁺; organic cations such as quaternary ammonium cations, quaternary pyridinium cations, quaternary imidazolium cations, quaternary phosphonium cations, tertiary sulfonium cations, and the like. It should be noted that in examples of anionic exchange membranes or cationic exchange membranes, the counterion is present with the ligand-metal complexes of the present disclosure. The counterion is incorporated into the ligand-metal complex by virtue of the respective starting material, for example a metal salt or metal compound comprising one of the aforementioned metals as well as one of the aforementioned counterions. When incorporating one or more of the ligand-metal complexes comprising a metal and a counterion into an ion exchange membrane, the counterion integral to the ion exchange membrane may be replaced with a cation or anion being exchanged during use of the ion exchange membrane.

Examples of the present disclosure include ion-exchange membrane, including a polymer comprising vinylpyridine monomer units and a metal complex, wherein the polymer is functionalized via coordinate covalent bonds with the metal complex. The polymer can include poly(4-vinylpyridine), styrene, or combinations thereof, such as poly(4-vinylpyridine-co-styrene). Poly(4-vinylpyridine) can also be copolymerized with other monomers such as acrylonitrile, styrene, acrylate, methacrylate, ethylene, propylene, or butadiene to form a copolymer. In examples, the metal complex includes nickel, although other metals may be used. Some examples of the metal complex include the formation of [Cu(bipy)₂]²⁺, using 2,2′-bipyridyl coordinated to copper (II) ions. [Ni(bipy)₂]²⁺, using 2,2′-bipyridyl and nickel (II), [Zn(bipy)₂]²⁺, using 2,2′-bipyridyl and zinc(II), and complexes using ruthenium, iron, cobalt, and other metals. Some examples of ligand of the ligand-metal complex include pyridine, 2,2′-bipyridine, 2,2′:6′,2″-terpyridine, quinoline, 2,2′-biquinoline, 1,10-phenanthroline, 8-hydroquinoline, 8-aminoquinoline, and substituted derivatives of thereof. Implementations may include where the metal complex comprises a nickel-bipyridine complex. In implementations of an ion exchange membrane, monomer units in a monomer unit of the polymer to ionic ligand-metal complex molar ratio is from about 100 to 1 to about 1 to 1. Membranes can be constructed of films wherein a film thickness is from about 250 nm to about 500 μm, or from about 1 μm to about 300 μm, or from about 50 μm to about 250 μm. In certain examples, ion-exchange membrane is a free-standing film, or alternatively, can be attached to a substrate or other component or layer within an electrochemical device. In the following examples, it should be understood that aforementioned metals, counterions, and ligands may be used in similar examples to provide an ion exchange membrane according to the present teachings.

### EXAMPLES

### Example 1 (Synthesis of Ni Complex)

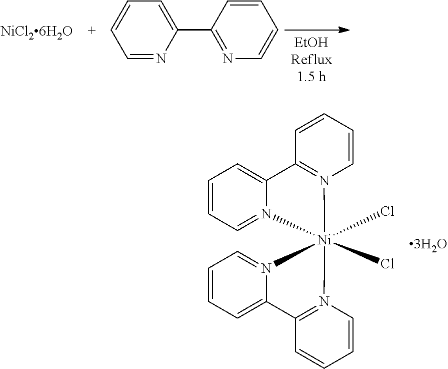

To a 500 mL flask, NiCl₂·6H₂O (5.0 g, 21.04 mmol) and EtOH (100 mL) were added to make a light green solution. Separately, to a 200 mL Erlenmeyer flask was added 2,2′-bipyridyl (6.57 g, 42.07 mmol) and EtOH (80 mL) to make a colorless solution. The bipyridyl solution was added to the NiCl₂ solution by pipette over ˜3 min at room temperature. The Erlenmeyer flask was rinsed with EtOH (20 mL) and added. The reaction mixture was refluxed for 1.5 h. The solvent was reduced by half by rotary evaporator and cooled down to room temperature. Acetone (200 mL) was added and kept stationary at room temperature. No precipitation formed immediately but upon scratching the flask wall with a spatula induced crystallization. The precipitate was then filtered and rinsed with acetone. After drying in a fume hood overnight, a light blue powder (6.95 g, 67% yield) was obtained. CHN analysis: Calculated for C₂₀H₂₂Cl₂N₄NiO₃: C, 48.43%; H, 4.47%; N, 11.30%. Found: C, 48.33%; H, 4.76%; N, 11.06%. FTIR (ATR, cm⁻¹): 3454, 3101, 3031, 1673, 1597, 1574, 1490, 1473, 1441, 1311, 1249, 1175, 1155, 1104, 1058, 1044, 1020, 913, 769, 736, 652, 633, 509, 475, 420.

### Example 2 (Synthesis of PVP—Ni Complex)

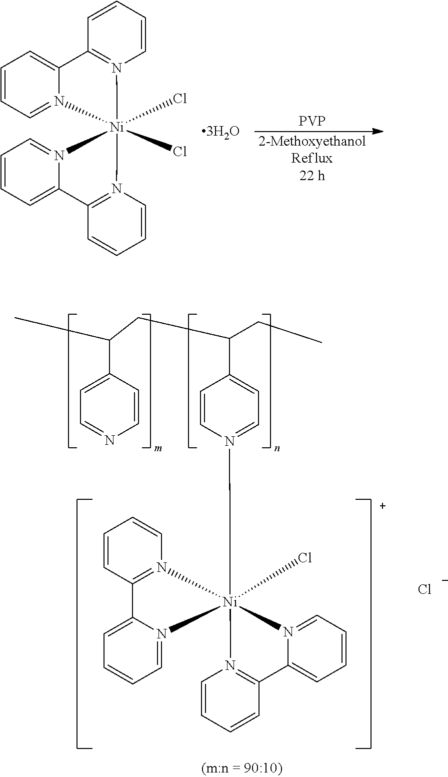

To a 250 mL flask poly(4-vinylpyridine) (1.0 g), Ni(bipy)₂Cl₂·3H₂O complex (0.47 g, 0.95 mmol) and 2-methoxyethanol (15 mL) were added: (monomer unit:Ni complex=10:1 molar ratio). The solids gradually dissolved when heated, and the reaction mixture was refluxed for 22 h at 124° C. Upon cooling, the reaction mixture formed a gel. The gel was liquefied by adding 2-methoxyethanol (10 mL) and heating at 80° ° C. The hot reaction mixture was poured into hexane (250 mL) to form a gel-like precipitate which was collected and re-dissolved in 2-methoxyethanol (30 mL) at 70° C. The solution was added into diethyl ether (250 mL) dropwise to form a white precipitate. The precipitate was filtered and rinsed with diethyl ether (50 mL) on filter paper. After drying under vacuum, slightly greenish powder (1.24 g, 87% yield) was obtained.

### Example 3 (Synthesis of PVP-10% PS—Ni Complex)

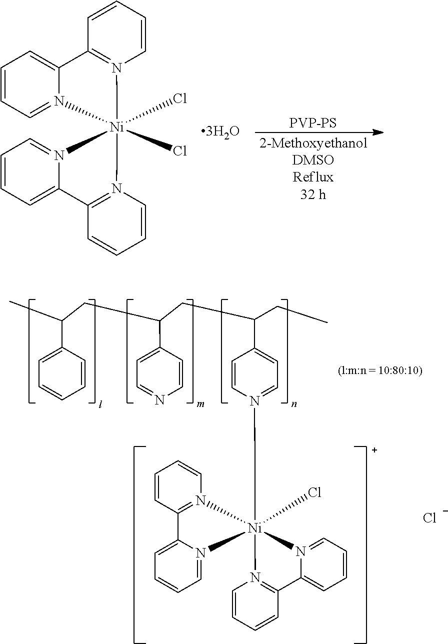

To a 250 mL flask poly(4-vinylpyridine-co-styrene) (2.0 g), Ni(bipy)₂Cl₂·3H₂O complex (0.94 g, 1.90 mmol) and 2-methoxyethanol (60 mL) were added: (monomer unit:Ni complex=10:1 molar ratio). The reaction mixture was refluxed for 19.5 h at 124° C., but soft polymer still remained undissolved in a blue-green solution. 2-methoxyethanol (40 mL) was added and reflux continued for 24.5 h total, but polymer still remained undissolved. DMSO (20 mL×3) was incrementally added and reflux continued until the solids were fully dissolved after 30 h total. Reflux was continued for additional 2 h after the full dissolution, then the reaction mixture was cooled to room temperature. Diethyl ether (500 mL) was slowly added to the reaction mixture to form precipitate. The precipitate was filtered and rinsed with diethyl ether (50 mL×4) on filter paper. After drying under vacuum, a slightly greenish powder (2.48 g, 87% yield) was obtained.

### Characterization of Polymer-Ni Complex Materials

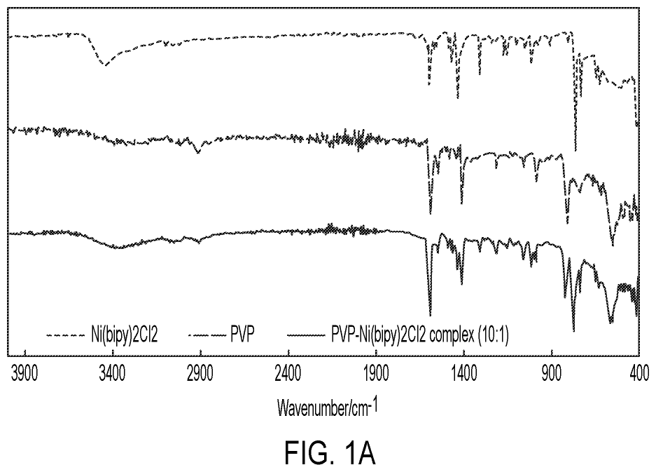

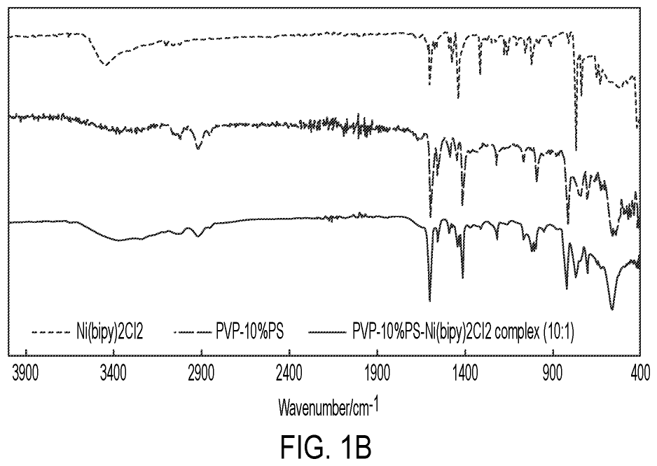

FIGS. 1A and 1B depict Fourier Transform Infrared (FTIR) spectra of polymer-Ni complex materials and starting materials including a PVP—Ni complex and a PVP-10% PS—Ni complex, respectively, in accordance with the present disclosure. The polymer-Ni complex materials obtained were measured using FTIR and exhibited overlaid FTIR spectra of starting materials, implying complex formations between the polymers and Ni(bipy)₂Cl₂. As shown in FIGS. 1A and 1B, the top curve represents the Ni complex, the middle curve represents the base polymer, and the bottom curve represents the polymer-Ni complex. Increase of glass transition temperature (T_{g}) has been reported in the case of Ru complexes in the literature. The polymer-Ni complex materials showed similar trends, as shown in Table 1. T_{g}'s increased by about 50° C. for each material after the reaction with Ni(bipy)₂Cl₂. This data also confirms and supports the formation of polymer-Ni complexes.

| | T_{g} of base | T_{g} of polymer-Ni |
|---|---|---|
| Sample ID | polymer (° C.) | complex (° C.) |
| Example 2 (PVP-Ni complex) | 149 | 200 |
| Example 3 (PVP-10% PS-Ni | 149 | 199 |
| complex) | | |

### Table 1. Glass Transition Temperature (T_{g}) Data

### Example 4 (Preparation of PVP—Ni Complex Film)

PVP—Ni complex (0.1 g) and DMSO (1 mL) were added to a vial. A green solution was obtained by stirring the mixture at 60° C. The polymer solution was poured onto aluminum dish and dried on hotplate at 60° C. for 2.5 h to obtain a slightly green film which remained adhered to the dish. On the following day, the film became pink and turbid. It was then brittle and easier to peel off from the dish.

### Example 5 (Preparation of PVP-10% PS—Ni Complex Film)

The PVP-10% PS—Ni complex (0.1 g) and DMSO (2 mL) were added to a vial. A light green solution was obtained by stirring the mixture at 140° C. The resulting polymer solution was poured onto an aluminum dish and dried on a hotplate (70° C. for 15 min, then 80° C. for 20 min) to obtain a slightly green film, which was easily peeled from the dish.

### Ion Exchange Capacity (IEC)

IEC data are summarized in Table 2. The films of PVP—Ni complex and PVP-10% PS—Ni complex exhibited IEC of 1.02 and 0.88 meq/g, respectively. These data were close to theoretical IEC which was 1.29 meq/g for both films. (Theoretical IEC was calculated from moles of Ni complex and total mass of composition. Theoretical IEC (meq/g)=(moles of Ni complex)×(charge on the Ni ion)/(total mass of composition). The Ni-complex component was 10 mol % in these films and higher IEC can be potentially achieved by increasing the Ni-complex component as free pyridine units are still available to form the metal complex.

| Film Sample ID | Base material | IEC (meq/g) |
|---|---|---|
| Example 4 | (PVP-Ni complex) | 1.02 |
| Example 5 | (PVP-10% PS-Ni complex) | 0.88 |

### Table 2. Ion Exchange Capacity (IEC) Data of Films

While not limited to the materials described herein, the present teachings provide polymer films comprised of poly(4-vinylpyridine) and poly(4-vinylpyridine-co-styrene) which are functionalized via coordinate covalent bonds with ionic ligand-metal complexes. Simple and easy functionalization methods of poly(4-vinylpyridine) and poly(4-vinylpyridine-co-styrene) by post-polymerization modification of commercially available materials can be provided using ionic ligand-metal complexes. Furthermore, the monomer unit of the polymer:ionic ligand-metal complex ratio can be controlled by changing feeding ratio during functionalization. The base polymer can be modified by using alternate poly(4-vinylpyridine) copolymers having other comonomers than styrene in certain implementations. In addition, alternate implementations can include other ionic ligand-metal complexes by substitution of the metal as well as ligand species. The materials and methods of the present teachings provide free-standing and flexible films, or coatings on various substrates with good ion exchange capacity (IEC), which can be applied to use in membrane electrode assemblies (MEA) for CO₂ conversion, fuel cells, electrochemical cells, redox flow batteries, as well as other electrochemical devices. The present teachings may be applied to ionic exchange membranes, including anionic or cationic exchange membranes.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. An ion-exchange membrane, comprising:
a polymer comprising vinylpyridine; and
an ionic ligand-metal complex bonded to the vinylpyridine by a coordinate covalent bond.

2. The ion-exchange membrane of claim 1, wherein the ionic ligand-metal complex comprises nickel.

3. The ion-exchange membrane of claim 1, wherein the ionic ligand-metal complex comprises a metal selected from the group consisting of zinc, ruthenium, iron, and cobalt.

4. The ion-exchange membrane of claim 1, wherein the ionic ligand-metal complex comprises bipyridine.

5. The ion-exchange membrane of claim 1, wherein the ionic ligand-metal complex comprises pyridine, 2,2′:6′,2″-terpyridine, quinoline, 2,2′-biquinoline, 1,10-phenanthroline, 8-hydroquinoline, 8-aminoquinoline, or combinations thereof.

6. The ion-exchange membrane of claim 1, wherein the polymer comprises 4-vinylpyridine.

7. The ion-exchange membrane of claim 1, wherein the polymer further comprises styrene.

8. The ion-exchange membrane of claim 1, wherein the polymer further comprises 4-vinylpyridine and styrene.

9. The ion-exchange membrane of claim 1, wherein a monomer unit of the polymer to ionic ligand-metal complex molar ratio is from about 100 to 1 to about 10 to 1.

10. The ion-exchange membrane of claim 1, wherein a thickness of the ion-exchange membrane is from about 250 nm to about 500 μm.

11. The ion-exchange membrane of claim 1, wherein the ion-exchange membrane has an ion exchange capacity (IEC) of from about 0.25 mEq/g to about 5.00 mEq/g.

12. The ion-exchange membrane of claim 1, wherein the ion-exchange membrane is free-standing.

13. An ion-exchange membrane, comprising:
a polymer comprising vinylpyridine and styrene; and
an ionic ligand-metal complex bonded to the polymer by a coordinate covalent bond.

14. The ion-exchange membrane of claim 13, wherein the ionic ligand-metal complex comprises nickel.

15. The ion-exchange membrane of claim 13, wherein the ionic ligand-metal complex comprises bipyridine.

16. The ion-exchange membrane of claim 13, wherein the polymer comprises 4-vinylpyridine and styrene.

17. The ion-exchange membrane of claim 13, wherein a monomer unit of the polymer to ionic ligand-metal complex molar ratio is from about 100 to 1 to about 10 to 1.

18. The ion-exchange membrane of claim 13, wherein the ion-exchange membrane has an ion exchange capacity (IEC) of from about 0.25 mEq/g to about 5.00 mEq/g.

19. An ion-exchange membrane, comprising:
a polymer comprising a poly(4-vinylpyridine-co-styrene) copolymer; and
a nickel-bipyridine complex bonded to the polymer by a coordinate covalent bond.

20. The ion-exchange membrane of claim 19, wherein the nickel-bipyridine complex is bonded to a 4-vinylpyridine segment of the poly(4-vinylpyridine-co-styrene) copolymer by a coordinate covalent bond.
